(19) United States
(12) Patent Application Publication
(10) Pub. No.: US 2008/0066807 A1
(43) Pub. Date: Mar. 20, 2008

(54) Hot water supply device

(76) Inventor: Eiji Seki, Tokyo (JP)

Correspondence Address: SMITH PATENT OFFICE, 1901 PENNSYLVANIA AVENUE N W, SUITE 901, WASHINGTON, DC, 20006, US

(21) Appl. No.: 11/892,222

(22) Filed: Aug. 21, 2007

(30) Foreign Application Priority Data
Sep. 19, 2006 (JP) 2006-252782

(51) Int. Cl. G05D 11/16

(52) U.S. Cl. 137/114

(57) ABSTRACT

The Present invention provides a hot water supply device in which the temperature of hot water stored at high temperature in a hot water storage tank or the like can be lowered to a temperature for use at which the risk of scalding is prevented, when supplied to a hot water usage part, without need for cold water to be mixed with the high-temperature hot water. A hot water supply device comprising a hot water storage tank, a cold water supply line for supplying cold water to the hot water storage tank, a hot water supply line for supplying hot water from a hot water storage tank to a hot water usage part, and high-temperature hot water discharge prevention means provided, along a hot water supply channel of these lines, for preventing high-temperature hot water discharge to the hot water usage part. The high-temperature hot water discharge prevention means is configured from a heat exchanger means provided to effect heat exchange between hot water of the hot water supply line and cold water of the cold water supply line and a flow rate control means for controlling the flow rates of the hot water in the hot water supply line and cold water of the cold water supply line. The control of this flow rate control means is executed in response to the temperature of the hot water and the cold water.

### BACKGROUND OF THE INVENTION

1. Field of the Invention

The present invention relates to a hot water supply device of a hot water storage-type, such as an electric hot water heater, for supplying hot water stored in a hot water storage tank or the like to a hot water supply faucet or the like in a kitchen, bathroom or laundry or the like, and more particularly relates to a hot water supply device in which the temperature of the supplied hot water is lowered to a predetermined temperature or below by heat exchange between the high-temperature hot water from the hot water storage tank or the like and a cold-water on the supply side, for ensuring to prevent the hot water from being discharged at high-temperature.

2. Description of the Related Art

FIG. 4 schematically shows a known conventional hot water storage-type hot water supply device of this type.

In a brief description thereof, the symbol 1 denotes a hot water storage tank in which a high-temperature hot water heated to a high temperature is stored, the storage of the hot water heated to a predetermined temperature involving connection of a cold water supply line 2 for supplying running water or the like with the hot water storage tank 1 and provision either in the hot water storage tank 1 or along this line of a known heating source such as, for example, an electric heater or gas heater. A wide range of heating sources can be used as the heating source including those that utilize a gas expansion/compression processing as disclosed in, for example, Japanese Unexamined Patent Application No. 2005-308370.

The symbol 3 denotes a hot water supply line for supplying the high-temperature hot water of the hot water storage tank 1 to a hot water usage part 4 such as a hot water supply faucet or shower head or the like, a mixing valve 5 where cold water supplied via a branching line 6 branching from the cold water supply line 2 is mixed with the hot water to control the temperature of the hot water discharged from a discharge water line 7 via the hot water usage part 4 to prevent scalding caused by hot water discharged at an unnecessarily high temperature being provided along the hot water supply line 3.

That is to say, the effective application of the storage capacity of a hot water storage-type hot water supply device requires the temperature of the stored hot water to be very hot. However, because of the inherent danger of scalding by discharge of high-temperature hot water from a faucet or the like, the temperature of the discharged water is normally lowered by an operation involving lowering the temperature of the stored hot water or mixing the hot water with cold water in a mixing valve. However, a problem inherent to lowering the temperature of the stored hot water is an increased risk of running out of hot water resulting from the reduced quantity of accumulated heat thereof.

Accordingly, in most cases, a structure comprising a mixing valve 5 is used.

A known example of this mixing valve 5 is a high-temperature discharge prevention valve having the function of a housing integrated-type mixing valve configured by, in an integrated valve housing comprising a hot water supply part, a cold water supply part and a discharge part, the formation of hot water chamber for communicating with an upstream hot water supply part, formation of a cold water supply port for communicating the cold water supply part with a center, formation of a mixing chamber for water inflowing from a hot water supply passage from the hot water chamber and the cold water supply port, housing of a thermosensitive member shape memory alloy spring mixing chamber serving as an actuator that actuates a valve body to advance and retreat based on the detection of the temperature of the mixing water from the mixing chamber, and formation of the discharge part in the downstream side of the thermosensitive member (for example, see Japanese Unexamined Patent Application No. 2006-046527).

Using this high-temperature hot water discharge prevention valve, the shape memory alloy spring serving as an actuator can be utilized to facilitate hot water mixing at a set temperature whereupon, accordingly, when the valve is reopened whether having been closed for a short or a long time, a safe hot water of a set temperature can be discharged from a faucet or the like provided forward therefrom.

Meanwhile, while there is an absence of problems during normal operation of the high-temperature hot water discharge prevention valve described in Japanese Unexamined Patent Application No. 2006-046527 noted above when employed as the mixing valve 5, various factors including blocking by foreign objects, lifespan completion and faulty actuation can result in the discharge of high temperature water and, accordingly, a safety measure to deal with such occurrences needs to be devised.

An additional problem inherent to the high-temperature hot water discharge prevention valve described above is its increased cost due to its large number of constituent component parts and complex structure.

### SUMMARY OF THE INVENTION

With the foregoing conditions in mind, it is an object of the present invention to provide a hot water supply device in which the temperature of the hot water supplied to a hot water usage part from a hot water storage tank or the like of a hot water supply device such as an electric hot water unit or the like in which water is stored at high temperature can be lowered to a temperature that can be used without risk of scalding without need for cold water to be mixed with the high-temperature hot water.

The hot water supply device pertaining to the present invention (invention described in Claim 1) for satisfying this object comprises a cold water supply line for supplying cold water, a hot water supply line for supplying hot water to a hot water usage part, and a high-temperature hot water discharge prevention means provided, along a hot water supply channel of these lines to the hot water usage part, for preventing high-temperature hot water discharge to the hot water usage part, and is characterized in that the high-temperature hot water discharge prevention means is configured from heat exchanger means for effecting heat exchange between the hot water in the hot water supply line and the cold water in the cold water supply line and flow rate control means provided to control flow rates of the hot water in the hot water supply line and the cold water of the cold water supply line, and the flow rate control means is configured to execute control in response to the temperature of the hot water and the cold water.

The hot water supply device pertaining to the present invention (invention described in Claim 2) comprises a hot water storage tank in which heated water is stored, a cold water supply line for supplying cold water to the hot water storage tank, a hot water supply line for supplying hot water from the hot water storage tank to a hot water usage part, and a high-temperature hot water discharge prevention means provided, along a hot water supply channel of these lines to the hot water usage part, for preventing high-temperature hot water discharge to the hot water usage part, and is characterized in that the high-temperature hot water discharge prevention means is configured from heat exchanger means for effecting heat exchange between the hot water in the hot water supply line and the cold water in the cold water supply line and flow rate control means provided to control flow rates of the hot water in the hot water supply line and the cold water in the cold water supply line, and the flow rate control means is configured to execute control in response to the temperature of the hot water and the cold water.

The hot water supply device pertaining to the present invention (invention described in Claim 3) in the hot water supply device according to the Claim 1 or Claim 2, is characterized in that the flow rate control means provided in an outlet part on a hot water supply line side of heat exchanger means is configured to execute an open/close control of the outlet part in response to the temperature of the hot water.

The hot water supply device pertaining to the present invention (invention described in Claim 4) in the hot water supply device according to Claim 1, Claim 2, or Claim 3, is characterized in that the flow rate control means comprises a thermosensitive element for detecting hot water temperature, the thermosensitive element being configured to actuate and limit a quantity of cold water supplied through an inlet part when the temperature of the hot water detected by the thermosensitive element is a predetermined temperature or above.

The hot water supply device pertaining to the present invention (invention described in Claim 5) in the hot water supply device according to Claim 4 is characterized in that the flow rate control means is configured to execute an open/close control of a communication part for bypassing between the hot water supply line and the cold water supply line and configured to open a communication part so that the water passes from a cold water supply side to a hot water supply side when the temperature of the hot water detected by the thermosensitive element is a predetermined temperature or above to ensure a supply of hot water at a predetermined temperature or below.

The hot water supply device pertaining to the present invention (invention described in Claim 6) in the hot water supply device according to any one of Claims 1 to 5, is characterized by employing, as flow rate control means, a thermosensitive actuator, comprising a thermosensitive element, for executing a flow rate control of the cold water supply line and the hot water supply line actuated in accordance with the temperature of the hot water detected by the thermosensitive element.

According to the hot water supply device pertaining to the present invention as described above, because a heat exchanger part serving as high-temperature hot water discharge prevention means is configured by arrangement of a cold water supply line for supplying cold water and a hot water supply-side line for supplying hot water heated to a high temperature in alignment and in close proximity, the temperature of the hot water at the cold water side can be lowered by the heat exchange therebetween to prevent high-temperature hot water discharge in which the risk of scalding by the temperature of the discharged water is prevented and, in turn, to ensure the hot water can be supplied at the desired temperature. In addition, because the water of the cold water side is warmed by the high-temperature hot water, a saving on the energy and time required to heat the water can be achieved.

The present invention is additionally advantageous in that, unlike in the conventional art, the need for high-temperature hot water of a temperature of the order of the 100° C. or 80° C. to be stored in the hot water storage tank is eliminated and an adequate discharge water quantity of high-temperature hot water of a temperature of the order of, for example, 60° C. can be ensured, the durability of the associated lines and devices and so on can be improved.

Furthermore, while it is clear that in the present invention a structure for ensuring the maximum surface area of the heat exchanger unit is adopted, a drop in the temperature of the supplied hot water caused by reduction of the heat exchanger surface area (heat transfer surface area) and increased temperature of the supplied cold water can be dealt with by detection of the temperature of the supplied hot water supply by temperature detection means such as a sensor or a thermosensitive element, and implementation of a reduction control of the overall flow rate and slowing of the flow velocity to stimulate heat exchange. In addition, when the hot water temperature fails to drop despite the flow velocity having been slowed, a measure based on implementation of a stopping control of the supplied hot water to prevent the supply of hot water and the user being made aware of this state can be devised.

The present invention is additionally advantageous in that, when an abnormality in the hot water discharge temperature described above occurs when the flow rate control in the heat exchanger line is being controlled at a cold water side inlet part, the temperature of the hot water can be instantaneously lowered to a predetermined temperature or below as a result of a communication part provided to bypass between the cold water supply-side line and the hot water supply-side line being opened to allow the water of the cold water supply side to be directly mixed with the hot water of the hot water supply side.

The present invention is additionally advantageous in that, because it is configured by employment as flow rate control means of a thermosensitive actuator in which a thermosensitive element for detecting hot water temperature is assembled, unlike in the conventional art a component part such as a pump that for which power is required is unnecessary and, accordingly, both power consumption and the number of component parts thereof can be reduced.

The present invention is further advantageous in that, because the heat exchanger unit does not constitute a structure in which the region for the mounting thereof is restricted and, unlike in the conventional art, it can be mounted in any position between the hot water storage tank and the hot water usage part, an increased degree of freedom in the layout of the hot water supply system is ensured and a simplification of the system configuration can be achieved and, moreover, pressure loss and so on in a hot water supply circuit such as this is small.

### BRIEF DESCRIPTION OF THE DRAWINGS

FIG. 1 is a schematic configuration diagram of one embodiment of the application of a hot water supply device pertaining to the present invention as a hot water storage-type hot water supply device;

FIGS. 2A and 2B are schematic explanatory diagrams of outlet flow rate control performed by a heat exchanger unit of the hot water storage-type hot water supply device of FIG. 1;

FIGS. 3A, 3B and 3C are schematic explanatory diagrams of inlet flow rate control performed by the heat exchanger unit of the hot water storage-type hot water supply device of FIG. 1; and

FIG. 4 is a schematic diagram of a conventional hot water storage-type hot water supply device.

### DESCRIPTION OF THE PREFERRED EMBODIMENTS

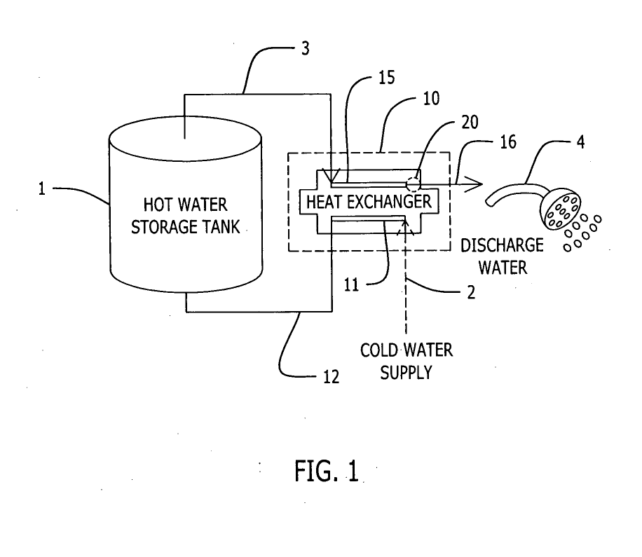

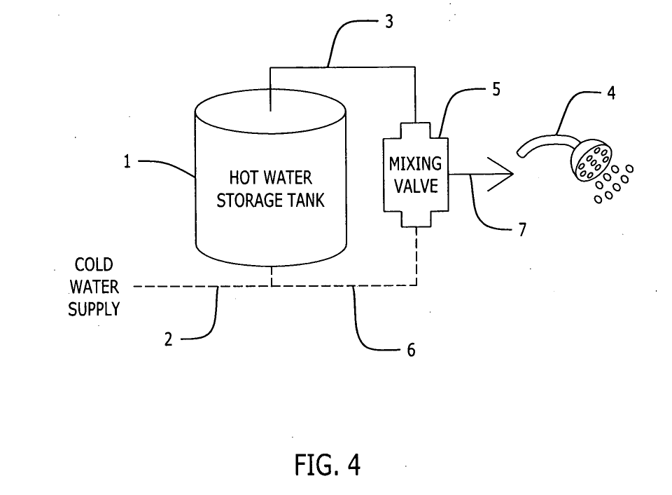

FIG. 1 shows one embodiment of a hot water supply device pertaining to the present invention, identical symbols having been assigned in the diagram to sections identical or equivalent to those of FIG. 4 with the description thereof being omitted.

As in the description of FIG. 4 given earlier, this embodiment describes a hot water storage-type hot water supply device comprising a hot water storage tank 1 in which heated water is stored.

This embodiment, which constitutes a hot water storage-type hot water supply device heated water comprising a hot water storage tank 1 for storage of heated water, a cold water supply line 2 for supplying cold water such as the water from a running water supply or the like to the hot water storage tank 1, and a hot water supply line 3 for supplying high-temperature hot water from a hot water storage tank 1 to a hot water usage part 4, is characterized by the high-temperature hot water discharge prevention means provided, along a hot water supply channel of the cold water supply and hot water supply lines 2, 3 to the hot water usage part, for preventing high-temperature hot water discharge to the hot water usage part 4, the high-temperature hot water discharge prevention means being configured from a heat exchanger unit 10 provided to effect heat exchange between hot water of the hot water supply line 3 and cold water of the cold water supply line 2 and a thermosensitive actuator 20 serving as flow rate control means provided to control the flow rates of the hot water of the hot water supply line 3 and the cold water of the cold water supply line 2, and the thermosensitive actuator 20 being configured to control the temperature of the hot water and the cold water.

Here, the heat exchanger unit 10 serving as heat exchanger means is configured as heat exchanger lines 15, 11 based on arrangement of a portion of the hot water supply line 3 and a portion of the cold water supply line 2 in alignment and in close proximity. The symbol 12 in the diagram denotes a hot water supply line for supplying cold-water side water warmed by the heat exchanger unit 10 to the hot water storage tank 1, and the symbol 16 denotes a discharge water line for supplying hot water cooled by the heat exchanger unit 10 to the hot water usage part 4.

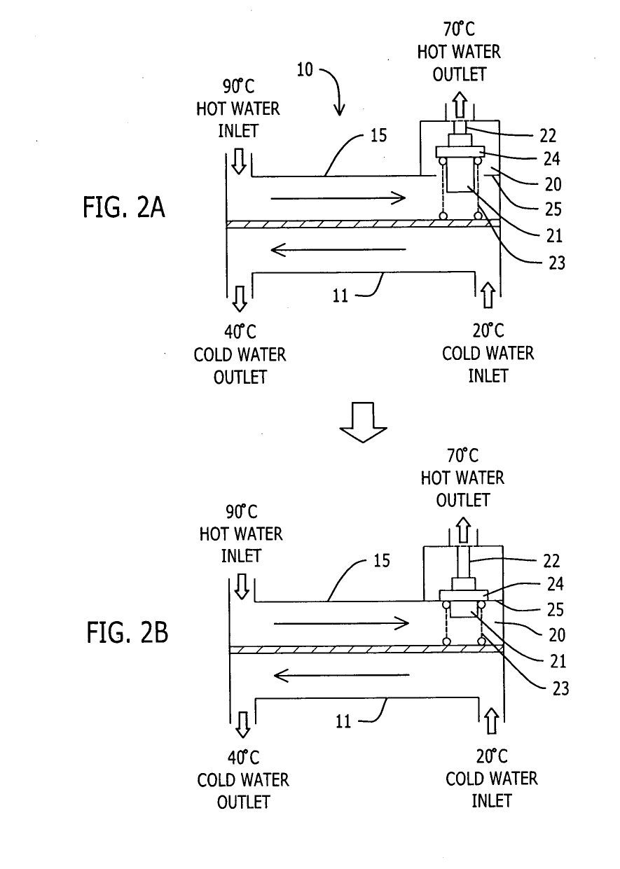

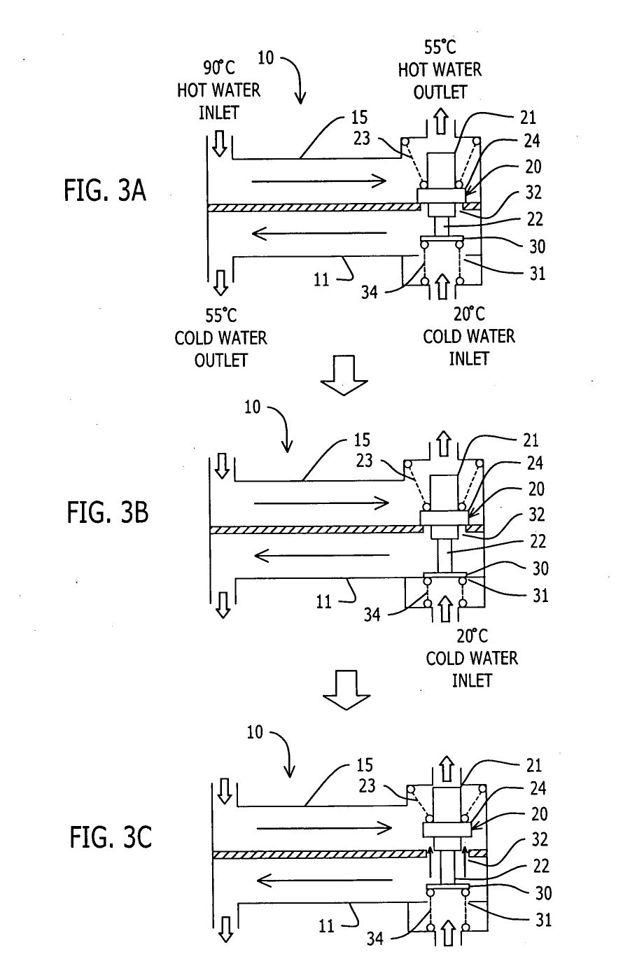

In addition, as shown in FIG. 2 and FIG. 3, the thermosensitive actuator 20 comprises a wax thermosensitive element or the like as thermosensitive mean and is configured to execute a flow rate control of the heat exchanger line 11 of the cold water supply line 2 and the heat exchanger line 15 of the hot water supply line 3 as a result of actuation based on temperature of the hot water detected by this thermosensitive element.

As shown in FIG. 2, this embodiment describes the provision of the thermosensitive actuator 20 in an outlet part of the heat exchanger line 15 of the hot water supply-side line 3 and configuring thereof to execute an open/close control of the outlet part in response to the temperature of the hot water.

In a detailed description of the thermosensitive actuator 20 serving as flow rate control means given hereinafter with reference to FIGS. 2A and 2B, the thermosensitive actuator 20 comprises a thermosensitive part 21 in which a wax thermosensitive element or the like for detecting hot water temperature is assembled and is configured so that, when the temperature of the hot water detected by this thermosensitive part 21 is a predetermined temperature or above, an actuating rod part 22 is actuated to project in the axial direction to control the quantity of hot water supplied through the outlet part.

Here, the symbol 23 in the diagram denotes a spring for urging the thermosensitive actuator 20 in the direction in which the actuating rod part 22 retreats and projects, the symbol 24 denotes a valve body part provided in the actuator main body, and the symbol 25 denotes an opening part of the hot water supply-side line 3 opened and closed by the valve body part 24.

In this configuration, if the temperature of the supplied cold water is 20° C. and the temperature of the high-temperature hot water supplied from the hot water supply tank 1 is 90° C., at a 100% heat exchange efficiency the temperature of the water of the cold water supply side is 55° C. and the temperature of the hot water of the hot water supply side will be 55° C. and, accordingly, a desired hot water supply is facilitated.

Provided the temperature of the hot water of the hot water supply side is a predetermined discharge temperature or below, the thermosensitive element will not respond and, as shown in FIG. 2A, the opened state of the hot water supply-side line 15 will be maintained and the pressure loss occurring at the hot water supply side will be essentially negligible.

In contrast, as shown in FIG. 2B, when the heat exchange efficiency is deficient and the temperature of the hot water at the hot water supply side reaches, for example, 70° C., actuation based on detection of this state by the thermosensitive element, projection of the actuating rod part 22 in the axial direction and closing of the opening part 25 by the valve body part 24 to slow the flow velocity and raise the heat exchange efficiency resulting in a lowering of the temperature of the hot water of the hot water supply side occurs.

When the temperature of the hot water at the hot water supply side drops to a predetermined temperature or below for some reason, a fully closed state of the opening part 25 is established and the supply of hot water supply is completely stopped. The user recognizes this state and able to be made aware that some kind of abnormality has occurred in the hot water supply device.

According to a hot water storage-type hot water supply device of this configuration, because the heat exchanger part 10 is configured by arrangement of the cold water supply line 2 for supplying cold water to a hot water storage tank 1 and the hot water supply-side line 3 for supplying hot water heated to a high temperature in alignment and in close proximity, the temperature of the hot water at the cold water side can be lowered by the heat exchange to ensure the supply of hot water at a desired temperature in which high-temperature hot water discharge is prevented and there is no risk of scalding by the temperature of the discharged water. In addition, because the water of the cold water side is warmed by the high-temperature hot water, a saving on the energy and time required to heat the water can be achieved.

Furthermore, according to this configuration, because the need for high-temperature hot water of a temperature of the order of the 100° C. or 80° C. to be stored in the hot water storage tank is eliminated and an adequate discharge water quantity of high-temperature hot water of a temperature of the order of, for example, 60° C. can be ensured, the durability of the associated lines and devices and so on can be improved.

FIG. 3 shows another embodiment of a hot water supply device pertaining to the present invention and, in this embodiment, a thermosensitive actuator 20 serving as flow rate control means is provided in an inlet part of the cold water supply line 2 side of the, heat exchanger unit 10 and is configured to execute an open/close control of the inlet in response to the temperature of the hot water.

Notably, identical symbols having been assigned in the diagram to sections identical or equivalent to those of FIG. 2 with the description thereof being omitted.

The thermosensitive actuator 20 serving as flow rate control means of this embodiment comprises a thermosensitive element for detecting the temperature of the hot water. The actuation indicated in FIGS. 3A, 3B and 3C occurs on the basis of temperature of the hot water detected by the thermosensitive element. That is to say, as shown in FIG. 3A, in the normal state at which the temperature of the hot water is a prescribed predetermined temperature or below, the actuating rod part 22 of the thermosensitive actuator 20 is in a contracted non-actuated state, a desired heat exchange occurring between the heat exchanger lines 11,15 at this time as a result of a communication part 32 formed between the later-described heat exchanger lines 11, 15 being closed by the valve body part 24 and an opening part 31 of the cold water supply-side line 2 being opened by a valve body 30 urged by a spring 34 provided in the tip end of the actuating rod part 22 of the thermosensitive actuator 20.

In addition, when the temperature of the hot water detected by the thermosensitive element of the thermosensitive actuator 20 is a predetermined temperature or above and a so-called heat exchange deficiency state is established, the actuating rod part 22 of the thermosensitive actuator 20 elongates to establish the state shown in FIG. 3B in which, as a result of the opening part 31 of the cold water supply-side line 2 being closed by the valve body 30 provided in the tip end of the actuating rod 22, the flow at the cold water supply side is slowed, the heat exchange deficiency is alleviated, and the temperature of the hot water at the hot water supply side is lowered.

On the other hand, when a further rise in the temperature of the hot water detected by the thermosensitive element is detected, the thermosensitive actuator 20 shifts upward in the diagram as shown in FIG. 3C to form an opened state between the valve body 30 and the opening part 31 of the cold water supply-side line 2 and, in addition, the communication part 32 formed between the heat exchanger lines 11,15 is opened by the valve body part 24 and, as a result, the temperature of the hot water is lowered by cold water flowing to the hot water supply side.

Moreover, high-temperature hot water discharge at this time is prevented by the outlet part of the hot water supply side heat exchanger line 15 being closed by the end part of the thermosensitive element 21 of the thermosensitive actuator 20.

That is to say, the communication part 32 is provided between the heat exchanger line 15 of the hot water supply line 3 and the heat exchanger line 11 of the cold water supply line 2 to bypass these two lines, the communication part 32 being open/close controlled by the valve body part 24 of the thermosensitive actuator 20 provided in the hot water supply-side line 3. When the temperature of the hot water detected by the thermosensitive element is a predetermined temperature or above, as shown in FIG. 3C, the communication part 32 between the cold water supply side and the hot water supply side is opened to allow direct mixing of cold water with the hot water supply side which lowers the hot water discharge temperature and ensures the hot water is supplied at the predetermined temperature or below.

To put this another way, according to the configuration described above, in the normal state as shown in FIG. 3A the thermosensitive actuator 20 opens the cold water supply side opening part and, with the communication part 32 in the closed state, heat exchange that ensures the hot water is supplied at the desired temperature is effected.

In addition, when the temperature at the hot water supply side is high resulting in the establishment of a heat exchange deficiency state, as shown in FIG. 3B, the actuating rod part 23 projects and closes the opening part 31 of the cold water supply side resulting in a slowing of flow and results in a lowering of the flow and, in turn, a lowering of the temperature of the hot water by the cold water.

Furthermore, when an abnormal state in which the temperature of the hot water supply side is a predetermined temperature or above is detected by the thermosensitive part 21 detects this state and the actuating rod part 23 is caused to project further. Subsequently, as shown in FIG. 3C, the communication part 31 opens and the cold water supply side cold water is directly mixed with the hot water supply side resulting in a forcible lowering of the temperature of the hot water of the hot water supply side.

The present invention is not limited to the structure described by the embodiments above and, naturally, the shape and structure and so on of each component part can be modified and altered as appropriate.

For example, the hot water supply device pertaining to the present invention is not restricted to an electric hot water heater described above and the same effect will be exhibited in the application of the hot water supply device in, for example, a bath heating unit or a non-hot water storage-type device (including configurations in which the hot water directly supplied from a heating source is fed to a hot water supply-side line).

In addition, the thermosensitive actuator serving as flow rate control means is not limited one in which a wax thermosensitive element is assembled and, instead, a shape memory alloy actuator may be employed.

This application is based on Japanese Patent Application No. 2006-252782 filed on Sep. 19, 2006, the contents of which are incorporated hereinto by reference.

What is claimed is:

1. A hot water supply device comprising:
a cold water supply line for supplying cold water;
a hot water supply line for supplying hot water to a hot water usage part; and
a high-temperature hot water discharge prevention means provided, along a hot water supply channel of these lines to the hot water usage part, for preventing high-temperature hot water discharge to the hot water usage part, wherein
the high-temperature hot water discharge prevention means is configured from heat exchanger means for effecting heat exchange between the hot water in the hot water supply line and the cold water in the cold water supply line and flow rate control means provided to control flow rates of the hot water in the hot water supply line and the cold water in the cold water supply line, and
the flow rate control means is configured to execute control in response to the temperature of the hot water and the cold water.

2. A hot water supply device comprising:
a hot water storage tank in which heated water is stored;
a cold water supply line for supplying cold water to the hot water storage tank;
a hot water supply line for supplying hot water from the hot water storage tank to a hot water usage part; and
a high-temperature hot water discharge prevention means provided, along a hot water supply channel of these lines to the hot water usage part, for preventing high-temperature hot water discharge to the hot water usage part,
wherein
the high-temperature hot water discharge prevention means is configured from heat exchanger means for effecting heat exchange between the hot water in the hot water supply line and the cold water in the cold water supply line and flow rate control means provided to control flow rates of the hot water in the hot water supply line and the cold water in the cold water supply line, and
the flow rate control means is configured to execute control in response to the temperature of the hot water and the cold water.

3. The hot water supply device according to claim 1, wherein
the flow rate control means, provided in an outlet part on a hot water supply line side of heat exchanger means, is configured to execute an open/close control of the outlet part in response to the temperature of the hot water.

4. The hot water supply device according to claim 1, wherein
the flow rate control means comprises a thermosensitive element for detecting hot water temperature,
the thermosensitive element being configured to actuate and limit a quantity of cold water supplied through an inlet part of heat exchanger line of cold water supply-side line when the temperature of the hot water detected by the thermosensitive element is a predetermined temperature or above.

5. The hot water supply device according to claim 4, wherein
the flow rate control means is configured to execute an open/close control of a communication part for bypassing between the hot water supply line and the cold water supply line and configured to open a communication part so that the water passes from a cold water supply side to a hot water supply side when the temperature of the hot water detected by the thermosensitive element is a predetermined temperature or above to ensure a supply of hot water at a predetermined temperature or below.

6. The hot water supply device according to claim 1, employing, as flow rate control means, a thermosensitive actuator, comprising a thermosensitive element, for executing a flow rate control of the cold water supply line and the hot water supply line actuated in accordance with the temperature of the hot water detected by the thermosensitive element.

7. The hot water supply device according to claim 2, wherein
the flow rate control means, provided in an outlet part on a hot water supply line side of heat exchanger means, is configured to execute an open/close control of the outlet part in response to the temperature of the hot water.

8. The hot water supply device according to claim 2, wherein
the flow rate control means comprises a thermosensitive element for detecting hot water temperature,
the thermosensitive element being configured to actuate and limit a quantity of cold water supplied through an inlet part of heat exchanger line of cold water supply-side line when the temperature of the hot water detected by the thermosensitive element is a predetermined temperature or above.

9. The hot water supply device according to claim 8, wherein
the flow rate control means is configured to execute an open/close control of a communication part for bypassing between the hot water supply line and the cold water supply line and configured to open a communication part so that the water passes from a cold water supply side to a hot water supply side when the temperature of the hot water detected by the thermosensitive element is a predetermined temperature or above to ensure a supply of hot water at a predetermined temperature or below.
